(19) United States
(12) Patent Application Publication
(10) Pub. No.: US 2016/0120120 A1
(43) Pub. Date: May 5, 2016

(54) Leaf Collection Device

(71) Applicant: Louis John Kovacs, Brampton (CA)

(72) Inventor: Louis John Kovacs, Brampton (CA)

(21) Appl. No.: 14/544,094

(22) Filed: Nov. 24, 2014

(30) Foreign Application Priority Data
Oct. 29, 2014 (CA) 2,868,913

(51) Int. Cl. A01D 11/06; A01D 7/00

(52) U.S. Cl. CPC A01D 11/06; A01D 7/00

(57) ABSTRACT

A leaf collection device to facilitate collection of leaves distributed on a ground surface into a leaf collection bag, the leaf collection device comprising: a frame defining a mouth and having a forward side and a trailing side, the frame being sized and shaped to attach at the trailing side to a periphery of an opening in the leaf collection bag, to maintain the bag opening coincident with the mouth of the frame; and a handle to provide a grip for a user to move the device, wherein the handle is attached to the frame and oriented towards the forward side of the frame; wherein, upon placing the device in a side position wherein the frame is adjacent to the ground, the device may be moved by the handle in a forward direction, and leaves on the ground may be raked into the bag through the bag opening.

### BACKGROUND

1. Technical Field

Embodiments of the present invention relate generally to gardening tools and, more particularly, but not exclusively, to a device that assists with raking and gathering leaves from a lawn.

2. Description of Related Art

During the fall months, large numbers of leaves are shed from trees and fall on grass lawns adjoining residential houses and other buildings. Raking and disposing of these leaves can be a tedious and time consuming task for homeowners and other caretakers of property.

Typically, the person removing the leaves will obtain a large bag, such as a plastic garbage bag or a strong paper bag expressly designed for gathering leaves. The bag is usually placed upright on the lawn. The leaves from a nearby portion of the lawn are swept into a pile with a rake or similar garden tool. The person will then usually bend over, grab a bundle of leaves with both hands, and straighten up and drop the leaves into the bag. After bending over several more times to dispose of all the leaves in the pile, the bag is moved and the process repeated as needed to remove the rest of the leaves on the lawn.

Disposing of leaves in the traditional way as described above can be physically uncomfortable and tiring, particularly for people with back problems or seniors. It can also be somewhat frustrating, since, for example, both the leaf bag and rake are prone to fall over periodically, and stray leaves will often fall out from the bundle being picked up. This requires yet further bending over and straightening up on the part of the caretaker.

### BRIEF SUMMARY

According to an aspect of the present invention, there is provided a leaf collection device to facilitate collection of leaves distributed on a ground surface into a leaf collection bag, the leaf collection device comprising:

a frame defining a mouth and having a forward side and a trailing side, the frame being sized and shaped to attach at the trailing side to a periphery of an opening in the leaf collection bag, to maintain the bag opening coincident with the mouth of the frame; and

a handle to provide a grip for a user to move the device, wherein the handle is attached to the frame and oriented towards the forward side of the frame;

wherein, upon placing the device in a side position wherein the frame is adjacent to the ground, the device may be moved by the handle in a forward direction, and leaves on the ground may be raked into the bag through the bag opening.

According to another aspect of the present invention, there is provided a method of collecting leaves distributed on a ground surface into a leaf collection bag, the method comprising:
attaching a frame having a mouth to an opening in the leaf collection bag, to maintain the bag opening coincident with the mouth of the frame;

placing the bag on a side so that the frame is adjacent to the ground;

pulling a handle attached and transverse to the frame in a direction forward of the bag opening; and

raking the leaves on the ground into an interior of the bag through the bag opening.

According to another aspect of the present invention, there is provided a leaf collection device to facilitate collection of leaves distributed on a ground surface into a leaf collection bag, the leaf collection device comprising:

a planar surface;

a ground-contacting element attached to the planar surface;

a frame attachable to the planar surface and defining a mouth and having a forward side and a trailing side, the frame being sized and shaped to attach at the trailing side to a periphery of an opening in the leaf collection bag, to maintain the bag opening coincident with the mouth of the frame; and

a pulling element operatively connected to the ground-contacting element, to provide a means for moving the leaf collection device;

wherein the device may be moved by the pulling element in a forward direction, and leaves on the ground may be raked into the bag through the bag opening.

According to another aspect of the present invention, there is provided a rake device to collect leaves distributed on a ground surface, the rake device comprising:

a handle having a grip end and a raking end;

a pair of heads including a fixed head and a movable head positioned proximate the raking end of the handle, the movable head being movable between a closed position wherein the pair of heads define a substantially enclosed space, and an open position wherein the pair of heads do not define a substantially enclosed space; and

a locking mechanism positioned proximate the movable head, to lock the movable head in the closed position and to release the lock of the movable head from the closed position, the locking mechanism being configured to lock the rake device in the closed position by application of force urging the movable head towards the fixed head; wherein a user holding the device at the grip end of the handle may move the movable head from the open position to the closed position by pressing a foot on the movable head.

According to another aspect of the present invention, there is provided a method of collecting leaves distributed on a ground surface, the method comprising:

moving a pair of heads attached to a raking end of a handle over a portion of the distributed leaves, wherein the leaves are positioned within a space defined by the heads;

pushing one of the heads towards the other head with a user's foot, to lock the heads into a position wherein the space between the pair of heads is substantially enclosed, and the portion of distributed leaves are trapped inside the substantially enclosed space between the heads;

moving the pair of heads defining the substantially enclosed space holding the trapped leaves to a position adjacent to a disposal area; and

releasing the lock to open the space between the pair of heads, so that the trapped leaves are released from between the heads and move into the disposal area.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 is a perspective view of a leaf collection device;

FIG. 2 is a perspective view of a frame and handle of the leaf collection device of FIG. 1, showing the handle transverse to the frame;

FIG. 3A is a perspective view of the leaf collection device of FIG. 1 showing a releasable lock between the handle and the frame in an unlocked position;

FIG. 3B is a perspective view of the leaf collection device of FIG. 1 showing the releasable lock between the handle and the frame in a locked position;

FIG. 4A is a perspective view of the leaf collection device of FIG. 1 showing a pivotable handle;

FIG. 4B is a perspective view of the leaf collection device of FIG. 4A showing the pivotable handle rotated to the back of the device;

FIG. 4C is a perspective view of the leaf collection device of FIG. 4A showing the device in an upright position;

FIG. 5A is a perspective view of the leaf collection device of FIG. 1 showing a relatively large overlap of portions of a side of the frame, and a relatively small frame area;

FIG. 5B is a perspective view of the leaf collection device of FIG. 1 showing a relatively small overlap of portions of a side of the frame, and a relatively large frame area;

FIG. 6A is a perspective view of an embodiment of the leaf collection device of FIG. 1, showing an expandable frame having a groove and wingnut configuration, where the expandable frame is compacted to a relatively small frame area;

FIG. 6B is another view of the embodiment of the leaf collection device of FIG. 6A, where the expandable frame is expanded to a relatively large frame area;

FIG. 6C is a perspective view of another embodiment of the leaf collection device of FIG. 1, showing an expandable frame having a rotatable connector, where the expandable frame is compacted to a relatively small frame area;

FIG. 6D is another view of the embodiment of the leaf collection device of FIG. 6C, where the expandable frame is compacted to a relatively small frame area;

FIG. 6E is another view of the embodiment of the leaf collection device of FIG. 6C, showing the rotatable connector in a position parallel to the side of the frame, where the expandable frame is expanded to a relatively large frame area;

FIG. 7A is a perspective view of the frame and bag protector of FIG. 1;

FIG. 7B is a perspective view of the leaf collection device of FIG. 1 in the upright position, showing the bag protector and the connection of the bag protector to the frame;

FIG. 8A is a perspective view of an embodiment of the leaf collection device of FIG. 1 having removable rake tines, showing a set of rake tines detached from the frame;

FIG. 8B is a perspective view of the embodiment of FIG. 8A, showing the rake tines attached to the frame;

FIG. 8C is a perspective view of a set of rake tines having a different tine size from the set of rake tines of FIG. 8A;

FIG. 8D is a perspective view of a detachable side of the frame having a flat profile;

FIG. 9A is a perspective view of another embodiment of the leaf collection device of FIG. 1, wherein the device has a planar surface and a ground-contacting element;

FIG. 9B is a perspective view of the leaf collection device of FIG. 9A, wherein the leaf collection device has a motor and a set of wheels, and is controlled by a wireless controller;

FIG. 10A is a perspective view of a rake device, showing a pair of heads on the rake device in an open position;

FIG. 10B is a perspective view of the rake device of FIG. 10A, showing the pair of heads in a closed position;

FIG. 11A is a side view of the rake device of FIG. 10A, showing the pair of heads in the open position and unlocked;

FIG. 11B is a side view of the rake device of FIG. 10A, showing the pair of heads in a first closed position;

FIG. 11C is a side view of the rake device of FIG. 10A, showing the pair of heads in a second closed position;

FIG. 11D is a side view of the rake device of FIG. 10A, showing the pair of heads released from the closed position;

FIG. 11E is a side view of the rake device of FIG. 10A, showing the pair of heads in the open position and unlocked, as in FIG. 11A;

FIG. 11F is a side view of the rake device of FIG. 10A, showing the pair of heads in the open position and locked;

FIG. 12 is a perspective view of the rake device of FIG. 10A, showing the locking mechanism;

FIG. 13A is a perspective view of a user pulling the leaf collection device in a forward direction, where the user is facing forward;

FIG. 13B is a perspective view of a user pulling the leaf collection device in a forward direction, where the user is facing the device and walking backward;

FIG. 13C is a perspective view of a user raking leaves into the leaf collection device;

FIG. 13D is a perspective view of the leaf collection device showing a rake gathering leaves in front of the leaf collection device;

FIG. 14A is a perspective view of a user holding the rake device and moving the raking end into leaves distributed on the ground;

FIG. 14B is a perspective view of the user of FIG. 14A pressing the movable head of the rake device with a foot, to move the heads of the rake to the closed position;

FIG. 14C is a perspective view of the user of FIG. 14A moving the raking end of the rake device to a disposal area; and

FIG. 14D is a perspective view of the user of FIG. 14A releasing the locking mechanism of the rake device, moving the pair of heads to the open position, and disposing of the leaves.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in commercially feasible embodiments are often not depicted in order to facilitate a less obstructed view of these various embodiments of the present disclosure.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise. It is understood that “at least one” is equivalent to “a”.

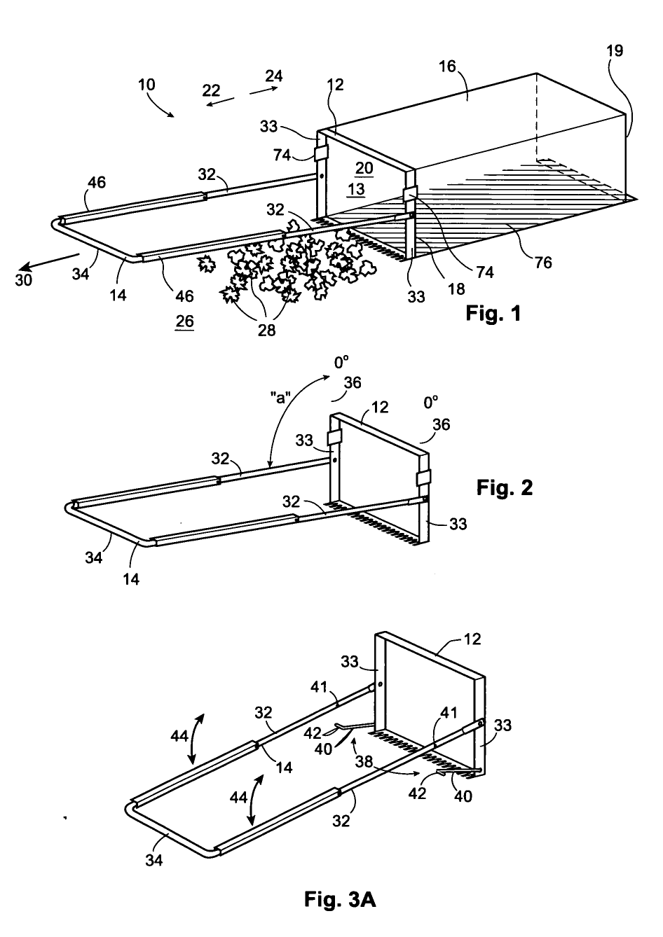

Referring now to FIG. 1, there is shown a leaf collection device 10. As indicated, leaf collection device 10 includes a frame 12 and a handle 14 attached to the frame. Handle 14 provides a grip for a user such as a caretaker (not shown) to move device 10.

A leaf collection bag 16 is shown attached to frame 12 at an open end 18 of bag 16. The opening into bag 16 created by open end 18 may be designated as bag opening 20. Leaf collection bag 16 also has a closed end 19 opposite to open end 18. Frame 12 has an internal opening or mouth 13. As shown in FIG. 1, frame mouth 13 lines up with bag opening 20 so that there is an open path through frame 12 into bag 16.

Frame 12 may be designated as having a front or forward side 22 and a back or trailing side 24. As shown in FIG. 1, leaf collection bag 16 attaches to frame 12 on the trailing side, and handle 14 is oriented towards the forward side of frame 12.

In the figures leaf collection device 10 is resting on a ground surface 26, such as a grass lawn, on which a number of leaves 28 are distributed. In FIG. 1 leaf collection device 10 is in a leaf gathering position, also called a side position, in which frame 12 is adjacent to ground 26. More particularly, in the example shown in FIG. 1 a side of frame 12 rests on ground 26.

When device 10 is in the side position, a user may grip handle 14 and pull leaf collection device 10 in the forward direction, as shown by arrow 30. As device 10 moves over ground surface 26, leaves 28 in the path of device 10 will gather or concentrate, for example forming a pile, on the ground in front of and adjacent to frame 12. Upon the user stopping forward movement of device 10, the gathered leaves as well as other stray leaves that may be near frame 12 may be conveniently swept or raked into leaf collection bag 16 through bag opening 20. In this way, leaf collection device 10 may be used to facilitate the collection of leaves 28 distributed on ground surface 26 into leaf collection bag 16.

According to some embodiments, handle 14 includes a pair of side bars 32 attached at opposing sides 33 of frame 12. Sides 33 are vertical when device 10 is in the leaf gathering position. Side bars 32 have a common length that is substantially the same as, or slightly longer than, a length of leaf collection bag 16 between opposing ends 18 and 19. As shown, the far ends of side bars 32 are joined by a cross-bar 34 so that handle 14 forms a “U” shape.

Cross-bar 34 functions as a substantially horizontal gripping portion for handle 14. While any part of handle 14 may be gripped, it is to be appreciated that horizontal gripping portion 34 provides a natural and comfortable gripping surface for some users. For example, horizontal gripping portion 34 enables users to grip handle 14 with both hands while keeping the user's upper arms and elbows substantially close to or in contact with the user's upper body. Further, gripping portion 34 allows the user's hands to rest in a relatively comfortable “palms up” or “palms down” position, and also enables control of the handle as a unit, i.e. including both side bars 32, with one hand.

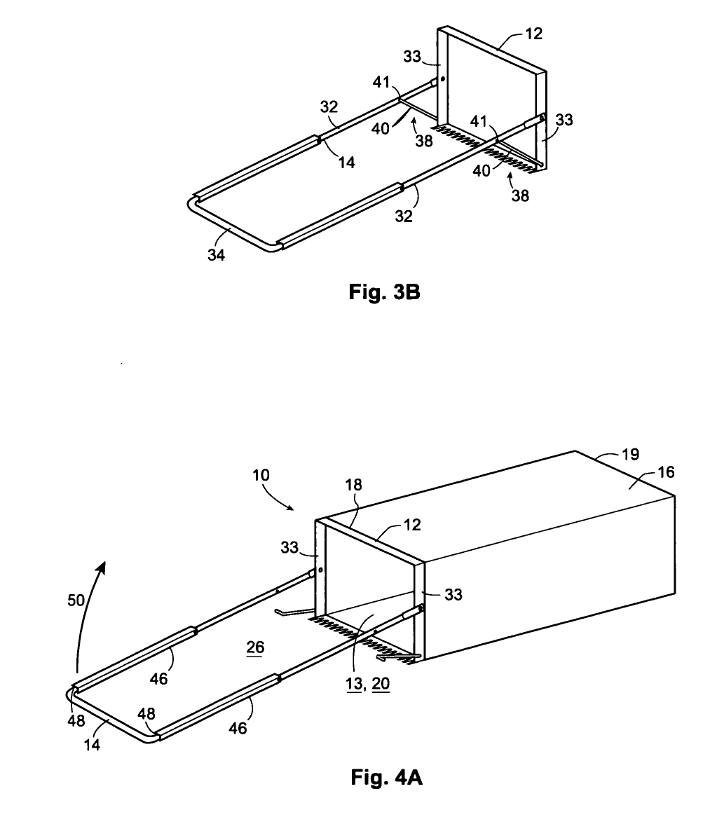

As noted above, handle 14 is oriented towards the forward side of frame 12. More particularly, handle 14 is oriented transverse to mouth 13 of frame 12. This is illustrated in FIG. 2, in which dashed lines 36 are drawn that project upwards from opposing vertical sides 33 of frame 12. Dashed lines 36 are in-line, or at zero degrees, with the plane formed by mouth 13 of frame 12. As shown, the transverse angle between handle 14 and mouth 13 of frame 12 is represented by letter symbol “a”. Handle 14 is transverse to frame 12 when it is in any position for which “a” is non-zero. Similarly, handle 14 is not transverse to mouth 13 of frame 12 when handle 14 is in-line with dashed lines 36 such that angle “a” is zero. As shown in the figures, handle 14 will be oriented in forward direction 22 for non-zero values of “a” in the forward direction.

Handle 14 may be fixedly attached to frame 12, such as for example that provided by a nut and bolt connection. Alternatively, according to some embodiments, handle 14 may be pivotally attached to frame 12, so that handle 14 may be moved over a range or arc of space.

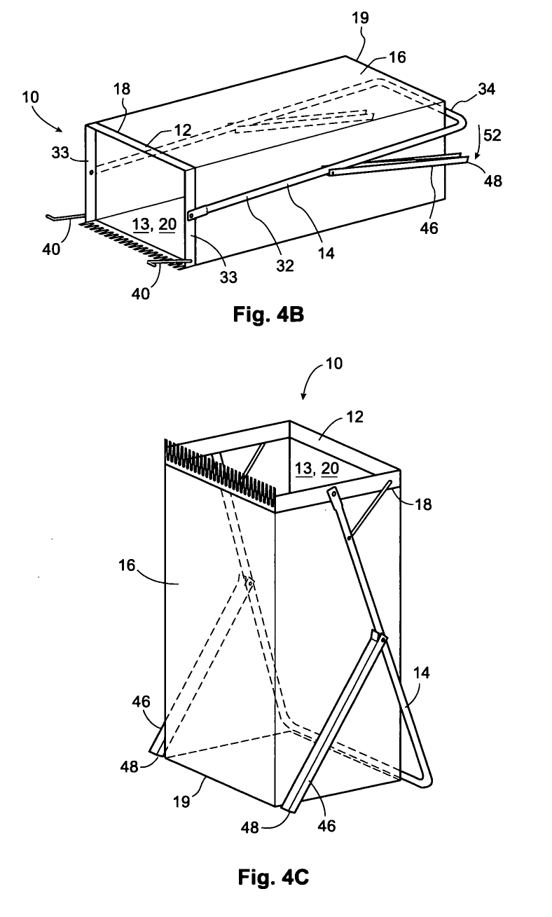

FIGS. 3A and 3B show a releasable lock 38 that may optionally be used with a pivotable handle 14. According to some embodiments, releasable lock 38 includes a connecting rod 40 and corresponding attachment node 41. As shown, it is advantageous for lock 38 to include two sets of rods 40 and nodes 41, one on either side of device 10, to provide a stronger and more stable lock.

Connecting rod 40 is pivotally attached to frame 12, such as at vertical side 33, and has an opposing free end 42 that is sized and shaped to attach to attachment node 41. More particularly, attachment node 41 may be a hole in side extension 32, and free end 42 may be a wire or pin sized and shaped to fit into and rest within the hole of node 41. The connecting rods 40 are sufficiently flexible so that the user can readily insert free ends 42 into holes 41, to fix or lock handle 14 in place, or may remove free ends 42 from holes 41, to permit handle movement, as desired. FIG. 3A shows free end 42 not inserted into the hole of node 41, so that releasable lock 38 is not locked and pivotable handle 14 is free to move, as shown by arc 44. FIG. 3B shows free end 42 inserted into the hole of node 41 so that releasable lock 38 is locked, and handle 14 is fixed in a position that is a forward orientation to frame 14.

It is to be appreciated that other embodiments of handle 14 are comprehended by leaf collection device 10, where handle 14 is attached to frame 12 and is capable of being oriented towards the forward side of frame 12 so that a user may pull device 10 in forward direction 30.

According to some embodiments, handle 14 may be pivotable over the entire range of available space, including to the trailing side 24 of frame 12. Leaf collection device 10 may be further configured so that, when handle 14 is pivoted to the trailing side, device 10 may be placed in a self-supporting upright position in which frame 12 and bag opening 20 are substantially above the ground, and leaf collection bag 16 is upright. In the upright position, handle 14 provides a base of support and functions as a support stand.

According to some embodiments, handle 14 may be configured as a support stand by including a pair of support legs 46, each of which is pivotally attached to a side bar 32. Support legs 46 attach to a point along the length of side bar 32 and extend to unattached termination points 48 located closer to the end of side bar 32, where side bar 32 meets cross bar 34. The pivotal attachment enables support legs 46 to be retractable, so that when retracted they are substantially co-linear with side bars 32, and when extended expose termination points 48. These points together with cross bar 34 form a base to support rake device 10 in the upright position.

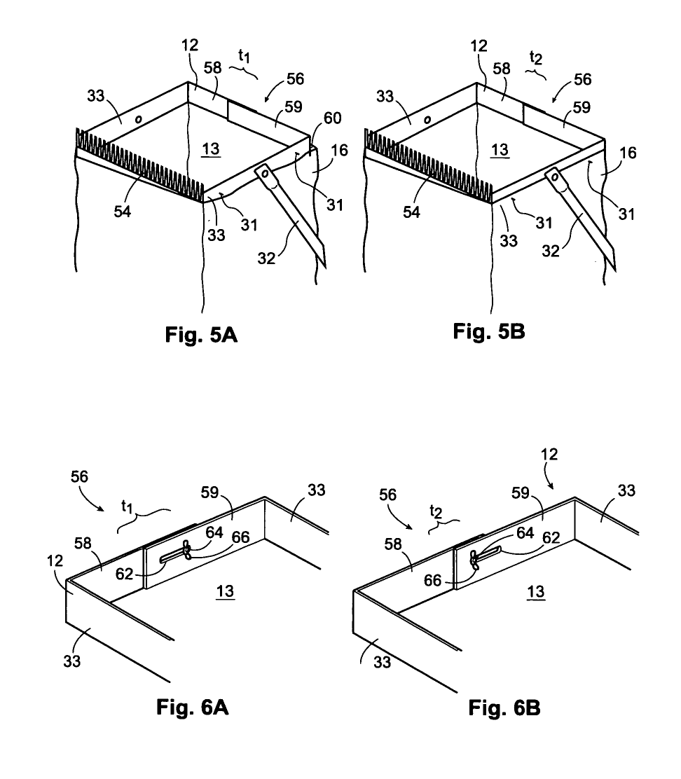

The transition of leaf collection device 10 from the side position to the upright position is shown in FIGS. 4A-C. In FIG. 4A device 10 is in the side position in which frame 12 is adjacent to ground 26 and mouth 13 of the frame is substantially perpendicular to the ground. As indicated by arrow 50, handle 14 is pivotable from forward side 22 to trailing side 24 of frame 12. As shown, in this position support legs 46 are substantially retracted, so that each side bar 32 maintains a substantially smooth profile.

FIG. 4B shows handle 14 pivoted to trailing side 24, with device 10 still in the side position. As indicated, in this position handle side bars 32 are adjacent to the sides of leaf collection bag 16, and handle cross bar 34 is behind closed end 19 of bag 16. In this position support legs 46 remain retracted, but may begin to extend away from the retracted position, as shown by arrow 52.

FIG. 4C shows leaf collection device 10 in the upright position, in which frame 12 is elevated substantially above ground 26, and frame mouth 13 is substantially parallel to the ground. As indicated, when pivoted to the trailing side 24 of frame 12, handle 14 may be configured to provide a base to support device 10 in the upright position. More particularly, from the side position of FIG. 4B, device 10 may be lifted so that frame 12 is substantially parallel to the ground, and support legs 46 pivoted so that termination points 48 extend away from side bars 32. In this way, termination points 48 together with cross bar 34 provide a stable base or plane of support to maintain rake device 10 in the self-supported upright position.

It is to be appreciated that in the upright position termination points 48 provide two points of support for rake device 10, and that cross bar 34, being a continuous bar, provides many points of support to enable rake device 10 to assume the upright position. When rake device 10 is moved back to the side position, support legs 46 may be moved back to the retracted or co-linear position shown in FIG. 4A.

It is to be appreciated that other embodiments of handle 14 that are convertible to a support stand may be used, and that in order to support rake device 10 in the upright position, when used as a support stand handle 14 should provide support on at least two sides of upright device 10.

The pivotal attachment of handle 14 to frame 12 may optionally be by an adjustable connector such as a wingnut. This type of attachment may be kept loose when using handle 14 to pull device 10 and when pivoting handle 14 to trailing side 24. The wingnut or other adjustable attachment may then be tightened to keep handle 14 in a fixed position when the handle is used as a base to hold device 10 in the upright position, and to provide greater stability.

According to some embodiments of handle 14, side bars 32 may be about 36 inches long, cross-bar 34 may be about 17 inches long, and support legs 46 may be about 24 inches long.

Frame 12 is sized and shaped to attach at trailing side 24 to a periphery of an opening in leaf collection bag 16, in such a way as to keep or maintain bag opening 20 substantially open and coincident with mouth 13 of the frame. As discussed above and shown in the figures, frame 12 attaches to a periphery of open end 18 of bag 16. In this way frame 12 prevents or reduces the extent to which opening 20 might close, crumble, or collapse, and thereby block or hinder the entry of leaves 28 into bag 20. More particularly, frame mouth 13 and bag opening 20 together form a continuous and substantially unobstructed opening that enables raked or swept leaves 28 to pass efficiently through frame 12 and into bag 16.

According to an option, frame 12 may be in the form of a rigid outer structure or periphery that defines the substantially hollow frame interior or mouth 13. As shown in the figures, the rigid outer periphery may be in the form of a rectangle. When in the side position, the two vertical oriented sides have been previously designated as sides 33, and the two opposing horizontal sides may be designated as side 54 and side 56. It may be noted that side 54 in this embodiment is adjacent to and in contact with the ground when device 10 is in the side position.

It is advantageous for the rigid outer periphery of frame 12 to be constructed from a material that is relatively strong and light, that is able to withstand the elements and large variations in temperature, and that maintains rigidity for long periods of time. Frame 12 may also be constructed from a combination of materials. Some examples of adequate materials are sheet metal, such as from steel, aluminum, or tin, and high strength plastic.

In the example shown in the figures, frame 12 is constructed from a single continuous piece of sheet metal having a uniform width, and that is bent in four corners to form a rectangle. Optionally, the two ends of the single piece metal may overlap on one side and be joined or fixed together by welding, glue, screws, or the like. In the examples shown, the horizontal above-ground side 56 (when device 10 is in the side position), is arranged to be the side where the two ends overlap and are fixed together.

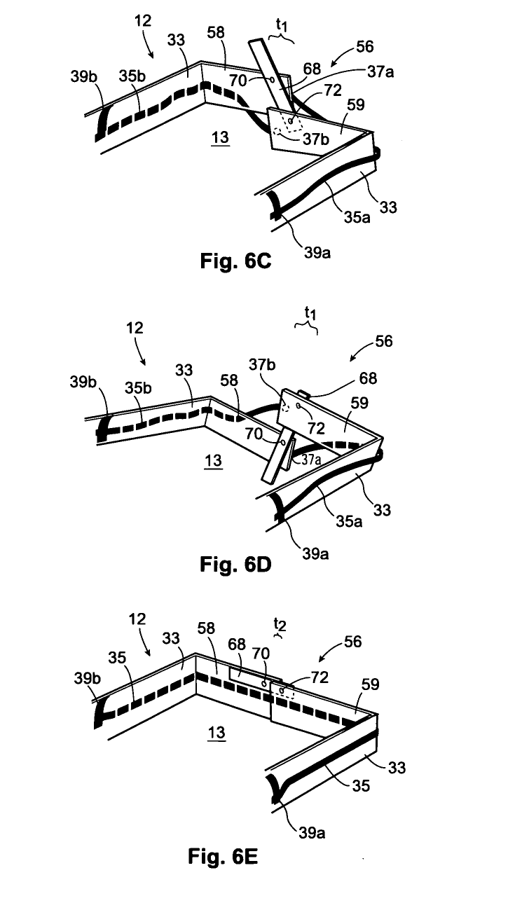

According to an option, frame 12 may be expandable in size, and the expandability feature may be used to form the tight attachment of frame 12 to leaf collection bag 16. This embodiment of frame 12 is shown in FIGS. 5A-B and 6A-E.

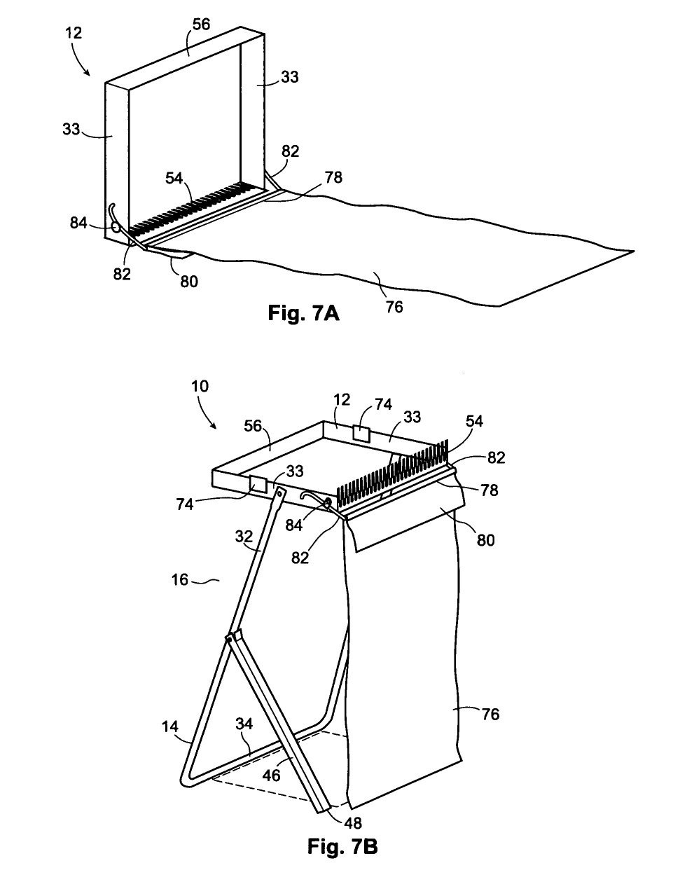

In these figures, device 10 is in the upright position, with frame 12 substantially above and parallel to the ground. As shown, side 56 of frame 12 contains the two overlapping segments of the frame, which are designated 58 and 59. The length of overlap between segments 58 and 59 is represented by the letter “t”, and the hollow interior or mouth 13 of frame 12 is shaded in FIGS. 6A-E for enhanced clarity. The suffix numbers “1” and “2”, used with overlap letter “t”, represent unexpanded (or compacted) and expanded states, respectively.

The two overlapping segments 58 and 59 have some inherent flexibility so that when pulled they are able to slide along their length, inward and outward against one another. This results in a greater or lesser overlap “t” between the two segments of side 56.

While the two opposing sides 33 and side 54 of frame 12 are each fixed in length, the length of side 56 can vary depending on the degree of overlap of segments 58 and 59. It is to be appreciated that a larger overlap “t” causes side 56 to be shorter, while a smaller overlap “t” leads to a longer side 56. Further, the overall perimeter and area of interior mouth 13 becomes smaller when side 56 is shorter, and similarly the perimeter and area of interior mouth 13 becomes larger when side 56 is longer.

Turning now to FIG. 5A, open end 18 of bag 16 is shown fitted around the outer perimeter of frame 12. Segments 58 and 59 are pulled close together so that overlap t1 is relatively large, and frame 12 is in the unexpanded state. This enables open end 18 to fit more easily around frame 12, so that there may be a small gap 60 between the frame and the bag. In FIG. 5B frame 12 is expanded, with relatively smaller overlap t2 and a longer side 56 and corresponding larger perimeter and area of mouth 13. This causes frame 12 to make substantially close contact with the inner surface of open end 18, eliminating or reducing the size of gap 60, and creating a tight connection of bag 16 to frame 12.

FIGS. 6A-E illustrate two embodiments by which overlap “t” may be expanded and contracted, leading to corresponding frame 12 contraction and expansion. In FIGS. 6A-B segment 59 is provided with a groove 62, and segment 58 has a fixed threaded post 64 that penetrates the groove. A wingnut 66 mounted on post 64 can be used to selectively tighten or loosen the connection between segments 58 and 59. In FIG. 6A segments 58 and 59 are pulled together so that overlap t1 is relatively large, and wingnut 66 is tightened to keep frame 12 in the unexpanded or smaller state. Similarly, in FIG. 6B the segments are pulled apart so that t2 is relatively small, and frame 12 is expanded. The desired length of side 56 may be determined by pulling the two segments 58 and 59 to the desired position, and the segments then set or fixed in place by tightening wingnut 66. Accordingly, it is to be appreciated that the segments are connectable to one another in a plurality of positions.

FIGS. 6C-E show another embodiment that enables adjustment of overlap “t”. As shown, an adjustment bar 68 is pivotally mounted to both segments 58 and 59, at pivot points 70 and 72 respectively. Adjustment bar 68 is between the two segments so that it is, for example, on the inner side of segment 58 and the outer side of segment 59. Pulling on either end of adjustment bar 68, as shown in FIGS. 6C and 6D, displaces adjustment bar 68 from the horizontal and brings segments 58 and 59 to a position where they are displaced vertically but also have a greater overlap “t1”. The overlap is minimized, and frame 12 expanded to the maximum, when adjustment bar 68 is made horizontal and substantially parallel to segments 58 and 59, that form side 56, as shown in FIG. 6E.

As shown above, bag 16 may attach to frame 12 by fitting open end 18 of bag 16 around the unexpanded outer periphery of frame 12, and then expanding frame 12 so that there is a tight or snug fit with frame 12. Accordingly, it is advantageous for frame 12 to be sized and shaped so that the area defined by the outer periphery is substantially the same, or slightly smaller, than the area defined by bag opening 20. It is to be appreciated that leaf collection bags 16 are often available commercially in a standard size of about 35 inches long, with an opening of about 16 inches×12 inches, and that frame 12 may be sized and shaped accordingly, with variations provided in regions or countries that commonly use bags 16 having a different standard sizes. According to some embodiments, the dimensions of frame 12 may be about 16 inches wide (sides 54 and 56 unexpanded) and about 10 inches high (sides 33).

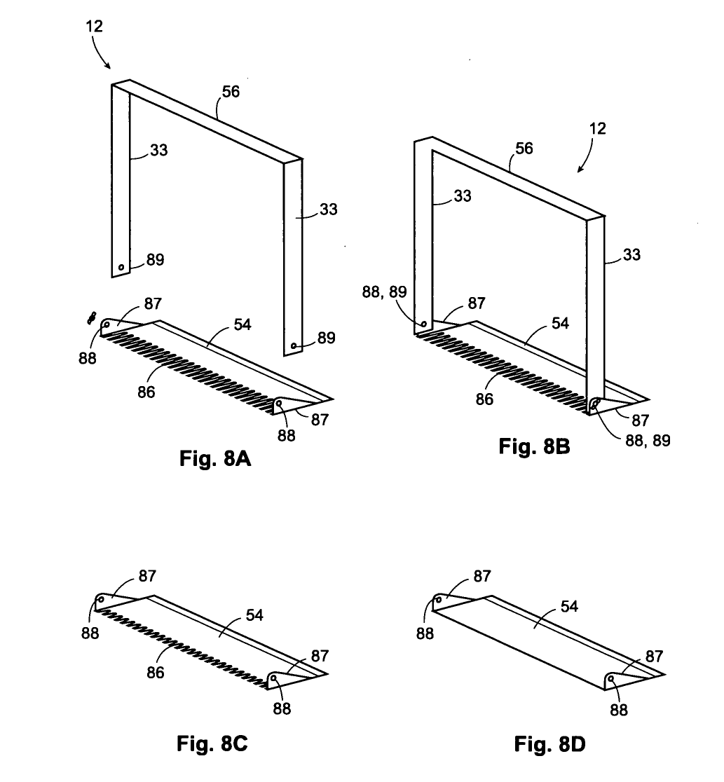

According to an option, a clip 74, sized and shaped to fit on frame 12, may be placed on frame 12 and over open end 18 of bag 16 to reinforce the attachment of bag 16 to frame 12. Any number of clips 74 may be used, for example one on each of two opposing sides as shown in the figures. Clips 74 may be made of a rigid metal or plastic with low elasticity, so that it forms a tight grip. Clips 74 are shown in FIGS. 1 and 7B.

According to an option, as shown in FIGS. 5A and 5B, relatively sharp pins 31 may be integrated into a side of frame 12. When bag 16 is attached to frame 12 as described above, pins 31 may puncture the bag to reinforce the attachment of bag 16 to frame 12.

According to an option, frame 12 may include a strap 35, or a pair of straps 35 located on the outer part of the frame, to hold bag 16 to the frame. FIGS. 6C-D show a pair of straps 35a and 35b, and FIG. 6E shows a single strap 35. In FIGS. 6C-D, strap 35a attaches to point 37a at the end of segment 58 and to a second attachment point 39a located adjacent to side 33 of the frame. Similarly, strap 35b attaches to point 37b at the end of segment 59 and to a second attachment point 39b located adjacent to the opposing side 33 of the frame. In FIG. 6E, single strap 35 attaches to attachment points 39a and 39b, with no intervening attachment points.

Attachment points 39 are close to a side of the frame but not directly on the surface of the frame, such as a connecting element attached to the frame, for example, so that there is space to insert bag 16 between strap 35 and frame 12. According to some embodiments, a convenient attachment point 39 may be, for example, connecting rod 82, shown in FIG. 7B and described in greater detail below.

In this way, when frame 12 is compacted, as shown in FIGS. 6C and 6D, straps 35, whether single or a pair, will be loose or slack, and bag 16 may be fitted under the straps next to the frame. When frame 12 is expanded, as shown in FIG. 6E, straps 35, whether single or a pair, will tighten against the frame and hold bag 16 to the frame. Straps 35 may similarly be used with other embodiments of frame 12, such as the embodiment of FIGS. 6A-B.

Where frame 12 is expandable, straps 35 are preferably composed of an inelastic material, and are sized and shaped to form a tight fit against the frame when the frame expands. According to an option, frame 12 may be fixed in size and not expandable. In such an embodiment straps 35 that are made of an elastic material, such as a bungee cord for example, may be used to hold bag 16 to frame 12.

According to an option, leaf collection device 10 may include a bag protector, also called a slide sheet 76. An embodiment of bag protector 76 is shown in FIGS. 1 and 7A-B.

As shown, bag protector 76 is a sheet of material that is operatively connected to frame 12, and that is sized and shaped to substantially cover the bottom side of leaf collection bag 16 when device 10 is in the side position. The bag protector accordingly protects all or most of the surface area of the bag that would otherwise be exposed to water or grass dampness, or a sharp object that may be on the ground, and thereby reduces the risk of the bag becoming weakened and/or torn. Bag protector 76 may also reduce surface friction, so that there is greater ease-of-movement when moving rake device 10 when in the side position.

The slide sheet may be made from a strong, thin, lightweight plastic or similar waterproof and flexible material that provides adequate protection from water and sharp objects and provides low friction when in contact with grass. It is also advantageous for bag protector 76 to be sized and shaped to have a width that is substantially the same as the width of bag 16, so that a larger part of the surface area of bag 16 is protected. For a standard leaf collection bag that has length of about 35 inches and width of about 16 inches, bag protector 76 may have a dimension that is slightly larger of about 42 inches long and about 19 inches wide.

As noted, bag protector 76 is operatively connected to frame 12. According to an option, as shown in FIGS. 7A-B bag protector 76 may be attached to a fixed, rigid holding rod 78, located adjacent to ground contacting side 54 of frame 12. Rod 78 is sized and shaped to be approximately the width of bag protector 76, and/or side 54. Rod 78 may be in the form of a long, narrow and thin metal piece that is bent into a wedge shape along its length. Rod 78 may hold bag protector 76 by any means suitable to hold a plastic sheet, such as screws or rivets. For enhanced security of attachment, bag protector 76 may attach to rod 78 at a distance from the end of bag protector 76, leaving an excess 80 of bag material.

As shown, rod 78 attaches to frame 12 by a connecting rod 82 on each side of the rod, that is gripped by a connecting element 84 fixed in place on each side 33 of frame 12. The length of connecting rod 82 between connecting element 84 and rod 78 is substantially the same on either side of the frame, so rod 78 is substantially parallel to side 54, and bag protector 76 is substantially parallel to the bottom side of bag 16. It is to be appreciated that other means of attaching bag protector 76 to device 10 are comprehended.

According to some embodiments, leaf collection device 10 may include rake tines 86, a plurality of pointed tines or teeth on ground contacting surface 54 that face the forward direction. Rake tines 86 may extend for all or part of the length of side 54. When device 10 is moved forward while in the side position, rake tines 86 help gather leaves together in a cluster or pile in front of frame 12.

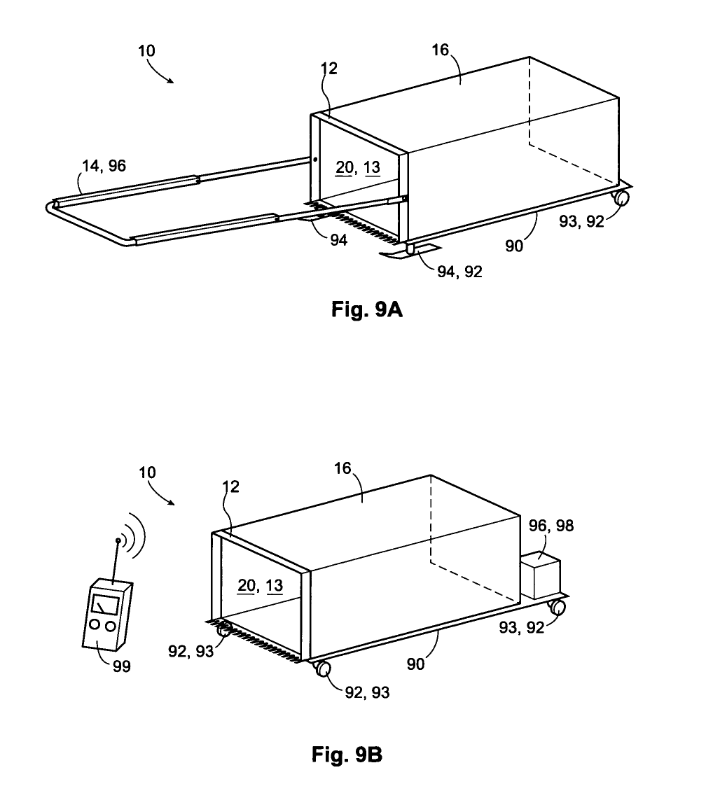

Rake tines 86 may be part of side 54 that is permanently attached to frame 12, or optionally may be part of side 54 that is removable from frame 12. FIG. 8A shows an embodiment of frame 12 having a continuous element of three sides, i.e. vertical sides 33 and upper side 56, and lower side 54 as a separate element. As a removable element, side 54 has side flanges 87 with apertures 88. Side 54 can be readily attached to sides 33 by aligning apertures 88 with corresponding apertures 89 in sides 33 and fixing side 54 in place with a bolt and wing-nut connection, as shown in FIG. 8B. It is to be appreciated that whether rake tines 86 are integral with frame 12 or removable from frame 12, rake tines 86 are configured to be in contact with the ground when leaf collection device 10 is in the side position.

Several embodiments of rake tines 86 are shown in the figures. In FIGS. 8A and 8B tines 86 are relatively long, spaced further apart, and fewer in number, while in FIG. 8C tines 86 are relatively smaller, closer together, and greater in number. The length of tines 86 may vary, and may for example extend past the width of sides 33 of the frame. Different rake tine sets may be selected according to the type of grass and size of leaves to be gathered. A contrasting example is shown in FIG. 8D, which is a straight edge with no rake tines 86. This embodiment may be suitable when collecting relatively large and discrete items such as golf balls from a lawn or fruit such as apples in an orchard.

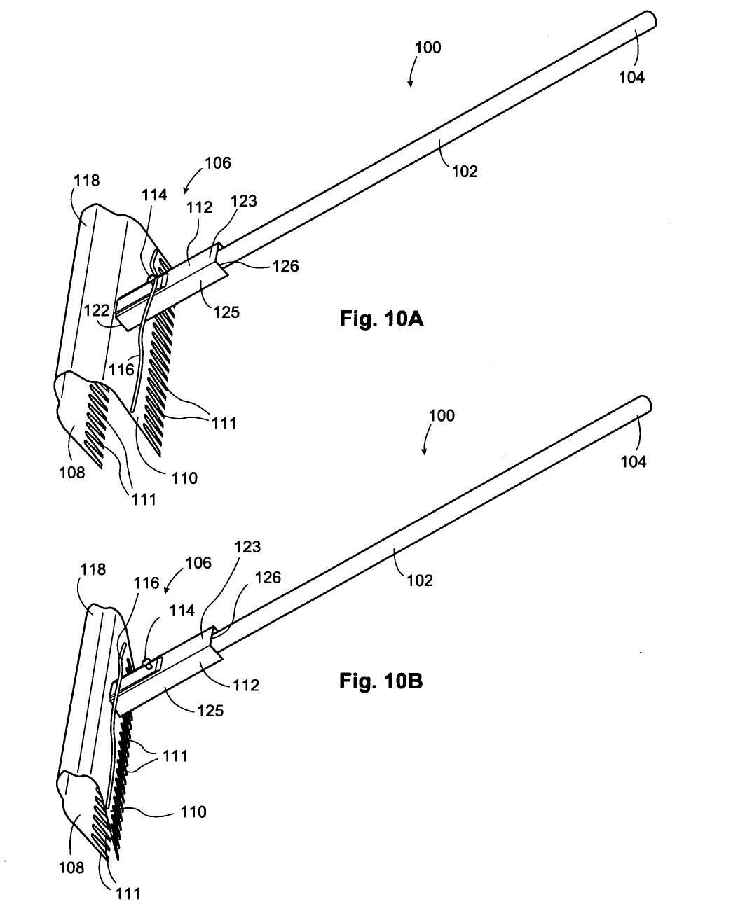

FIGS. 9A-B show another embodiment of leaf collection device 10. As indicated, this embodiment includes the additional elements of a planar surface 90 and a ground-contacting element 92 attached to the planar surface.

Frame 12 is attachable to the planar surface 90, in particular by fixing lower side 54 to the top side of planar surface 90. It is to be appreciated that in this embodiment side 54 is not ground-contacting, as it is in contact with planar surface 90. As with the previous embodiment, frame 12 is sized and shaped to attach at the trailing side to a periphery of an opening in leaf collection bag 16, to maintain bag opening 20 coincident with mouth 13 of the frame.

This embodiment includes a pulling element 96 that is operatively connected to ground-contacting element 92, to provide a means for moving leaf collection device 10. Pulling element 96 enables device 10 to be moved in the forward direction. As with the previous embodiment, upon stopping movement of device 10, leaves 28 on ground 26 may be raked into bag 16 through bag opening 20.

In the example of FIG. 9A, pulling element 96 is handle 14, which is oriented towards the forward side of the frame and provides a grip for a user to move device 10. In this embodiment handle 14 may be attached to either frame 12 or planar surface 90. Further, in this embodiment handle 14 and support legs 46 may need to be sized and shaped to be longer than in the previous embodiment, in order for device 10 to be placed in the upright position without interference from planar surface 90.

Planar surface 90 forms a base or undersurface to protect leaf collection bag 16 from dampness or sharp objects on the ground, and accordingly planar surface 90 replaces bag protector 76. Ground-contacting element 92 reduces friction with the ground so that device 10 may be moved in the forward direction relatively easily. More particularly, ground-contacting element 92 may be a set of four wheels 93 or runners 94, positioned at the four corners of planar surface 90. Optionally a combination of wheels and runners may be used, such as two front-positioned runners 94 and two rear-positioned wheels 93, as shown in FIG. 9A. Other elements that reduce friction may also be used for ground-contacting element 92.

It is advantageous to use wheels 93 with planar surface 90, as wheels enable improved mobility when device 10 is being moved while in the leaf gathering position. The wheels 93 may be fixed in orientation, or be pivotable to facilitate changes in direction. In particular, it is advantageous for the two wheels positioned at the front of rake device 10, to be pivotable. Wheels 93 may be made from a hard plastic or similar strong and lightweight material.

According to an option and as shown in FIG. 9B, a motor 98 may be included in device 10 as pulling element 96 to provide power to wheels 93. When the motor is activated, device 10 becomes self-propelled when in the leaf gathering position. If a wheel 93 is pivotable, for example the front two wheels as described above, device 10 may also include a remote control 99 operated by the user. More particularly, the user can use the remote control 99 to activate motor 98 and to steer the device by controlling the direction of the pivotable wheel, without physical contact.

For this embodiment handle 14 is optional, and is not present in FIG. 9B. If handle 14 is included, it may be used instead of motor 98, and may be pivoted to the trailing side, out of the way, when motor 98 is used. It is advantageous for handle 14 to use side bars 32 that are adjustable in length, such as telescopic, so that they can be shortened to rest on planar surface 90 when not in use, and lengthened when needed to put device 10 in the upright position.

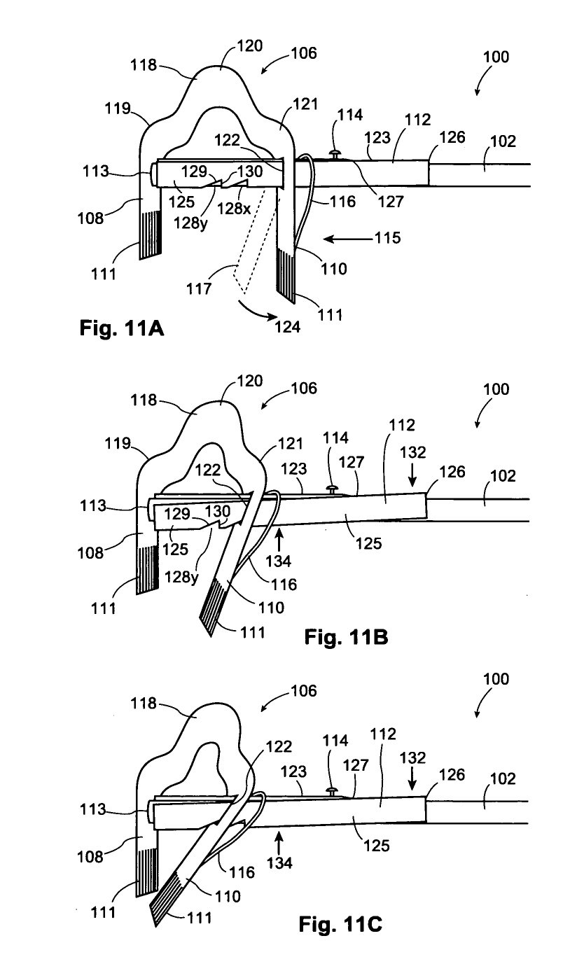

Leaf collection device 10 may be used with a rake device 100, shown in FIGS. 10-12. As will be shown in greater detail below, rake device 100 may also be used on its own to collect leaves 28 distributed on ground surface 26.

As shown in FIGS. 10A-B, rake device 100 includes a rake-handle 102 having a grip end 104 and a raking end 106. A pair of heads including a fixed head 108 and a movable head 110 are positioned proximate the raking end 106 of rake-handle 102. As shown each head terminates in a set of rake tines 111.

Movable head 110 is movable between an open position, shown in FIG. 10A, and a closed position, shown in FIG. 10B. In the open position, it can be seen that the two heads are spaced relatively far apart. Accordingly, in this position the space between the heads is open, and the pair of heads do not define a substantially enclosed space. In the closed position it can be seen that the two heads are relatively close at their edges, so that they are touching or separated by a relatively small space. Accordingly, in the closed position the space between the heads is relatively circumscribed or bounded, and the pair of heads define a substantially enclosed space. It may be noted that while in both positions the space on the sides of the heads remains relatively open, this does not affect the specification of open and closed positions since relatively few leaves will fall out of the sides when the heads are in the closed position and are held substantially horizontal.

Rake device 100 further includes a locking mechanism 112 positioned proximate the movable head 110. Locking mechanism 112 locks movable head 110 in the closed position, and also releases movable head 110 from the closed position. The locking mechanism 112 is configured to lock rake device 100 in the closed position by application of force urging the movable head 110 towards the fixed head 108. Accordingly, a user may move movable head 110 from the open position to the closed position by pressing or applying pressure on movable head 110 so that movable head 110 moves towards fixed head 108. This will engage locking mechanism 112 so that the pair of heads become locked in the closed position. It is to be appreciated that if the user is holding rake-handle 102 at grip end 104, a convenient way to apply this pressure on movable head 110 is with the user's foot. Rake device 100 also includes an attachment post 114 and a locking connector 116, which are described in greater detail below.

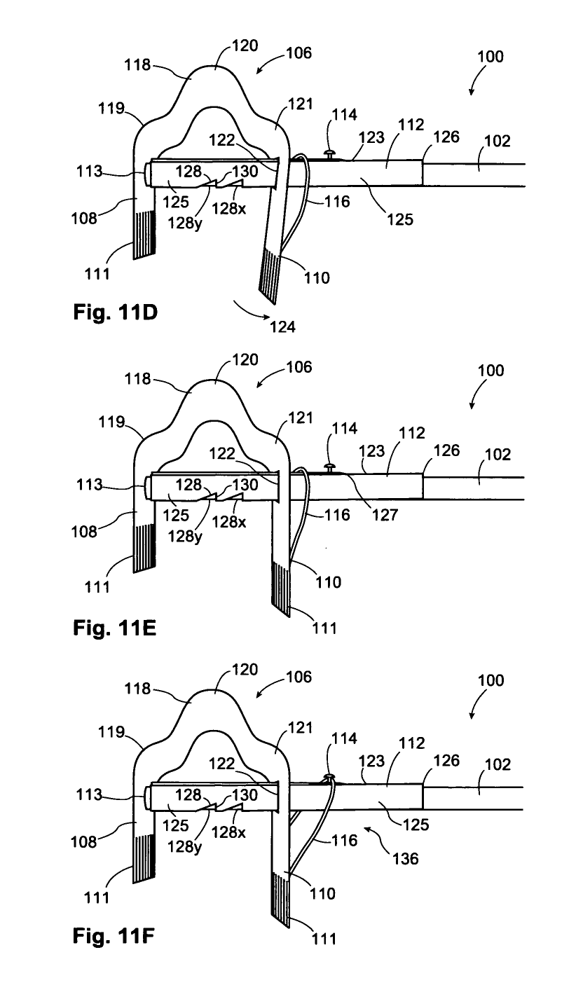

FIGS. 11A-F are a series of side views of raking end 106 that show rake device 100 moving between the open and closed positions.

As will be discussed below, it is advantageous that movable head 110 be configured to have an internal force, pressure, or bias urging it to move or return to the open position. Accordingly, when movable head 110 is moved away from the open position by an external force, and not locked in the closed position, it will return to the open position when the external force is released.

In the example shown in the figures, fixed head 108 and movable head 110 are opposing ends of a single piece of material 118. With reference to FIG. 11A, which shows rake device 100 in the open position, it may be seen that the very end or tip of raking end 106 may be designated end point 113. Material 118 is fixedly attached to rake-handle 102 at end point 113, which is just above fixed head 108. As a result, fixed head 108 is held firmly in place and stays relatively rigid, with little or no flex, when exposed to external pressure. It can be seen that beyond this fixed attachment continuous material 118 is bent or curved in three places, 119, 120, and 121, before intersecting rake-handle 102. Fixed head 108 and movable head 110 are the portions of continuous material 118 at the ends of the material on either side, and below rake-handle 102 as shown in the figures. A portion 122 of material 118 just above movable head 110 is cut out to accommodate rake-handle 102 and locking mechanism 112. Portion 122 may be seen with greater clarity in the perspective view of FIG. 10A.

As a result of this configuration, when movable head 110 is subject to an external force or pressure indicated by arrow 115, the curvature in material 118, and in particular curve 121, enable movable head 110 to bend or move away from the original, open position to a flexed position indicated by dashed outline 117. In that position the flex in material 118 and curve 121 create a bias, represented by arrow 124, urging movable head 110 towards the original open position. Accordingly, when external force 115 is removed, movable head 110 returns in the direction shown by arrow 124 back to the original, open position.

Optionally, a spring or other elastic material (not shown) may be used to bias movable head 110 to return to the open position. The spring may be placed adjacent to rake-handle 102 to reduce the risk of accidental damage.

Optionally, one or both heads may be removable from rake-handle 102. This would enable use of different heads with different size rake tines 111.

Some materials that may be suitable for use as single piece material 118 include plastics, polymers, and composite or carbon fibers. It is to be appreciated that other embodiments of the two heads are possible, including composing each head from a distinct and separate piece of material. In such an embodiment a spring may be used to bias movable head 110 to return to the open position.

As shown in the figures, according to an option locking mechanism 112 is a three-sided rectangular element that fits closely around rake-handle 102, and extends up rake-handle 102 to an end point 126 past the intersection with with cut-out portion 122. Accordingly locking mechanism 112 has a top surface 123 and two side surfaces 125. Locking mechanism 112 attaches to rake-handle 102 by attachment post 114, which is fixed in place on top surface 123. Attachment post 114 may be a screw, bolt or similar element.

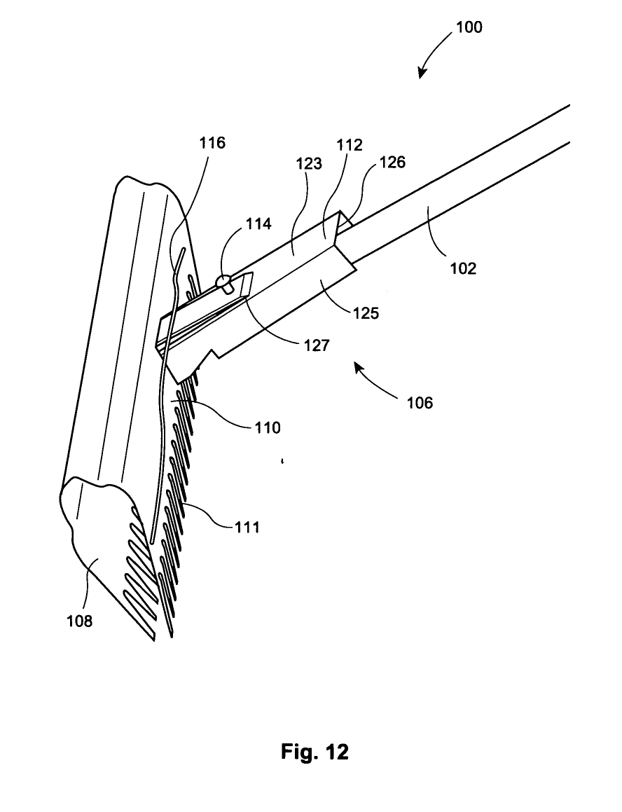

As may be seen in the figures and in particular in the perspective view of FIG. 12, there is an incision or cut along the two edges between top surface 123 and side surfaces 125. This incision extends from the far end of lock mechanism 112 adjacent rake-handle tip 113 up to a point 127 slightly past attachment post 114. As shown in FIG. 12, from point 127 to end point 126 of locking mechanism 112 there is no incision, and accordingly in that section top surface 123 and side surfaces 125 comprise a continuous and connected surface. In the example shown, in preparing locking mechanism 112 a bend may be made along the incision edges so that the part of top surface 123 between the incisions angles away from the rest of locking mechanism 112.

As shown in the figures, as a result of the incision and preparatory bending, side surfaces 125 flex or bend away from the horizontal. More particularly, the portion of side surfaces 125 that is cut away from top surface 123 bends in a downward direction, below top surface 123. Similarly, the portion of side surfaces 125 that is not cut away but remains attached to top surface 123, and that is contiguous with the cut away portion of side surfaces 125, naturally bends upward as the cut away portion bends downward, so that it is above the top surface of rake-handle 102. Point 127 effectively acts as a pivot point for side surfaces 125 bending away from the horizontal.

The incisions on both sides of top surface 123 and the pre-bending of the material in effect create an internal bias urging side surfaces 125 to bend away from the horizontal as described above. Accordingly, in the absence of any block or restraint, side surfaces 125 will bend away from the horizontal to the maximum range possible.

Optionally, a spring (not shown) such as a flat bar spring or a coil spring may be used to provide the internal bias of side surfaces 125.

Side surfaces 125 further include stop elements 128 in the form of notches. In the example shown there are two notches, designated 128x and 128y, with notch 128x positioned closer to movable head 110. Each notch is triangular-shaped, with a sloping side 129 and vertical side 130. Optionally, locking mechanism 112 may include one stop element or a plurality of stop elements on each side surface 125.

Turning now to FIGS. 11A-F, as noted FIG. 11A shows rake-device 100 in the open position. In this position locking mechanism 112 is in the rest position and is substantially horizontal, and is restrained from pivoting further downward or “off-horizontal”, because the bottom edges of side surfaces 125 are in contact with and blocked by the bottom edge of cut-out portion 122 of material 118.

Upon application of external force or push 115, movable head 110 is moved along the bottom edges of side surfaces 125, as shown by dashed outline 117 in FIG. 11A. Locking mechanism 112 remains substantially horizontal since it is still restrained by contact with the bottom edge of cut-out portion 122. However, as shown in FIG. 11B, upon movable head 110 being pushed far enough that it reaches notch 128x, there becomes available empty space in the notch between sloping side 129 and the bottom edge of cut-out portion 122. As a result side surfaces 125 have room to move, and accordingly pivot downward, away from the horizontal. This causes movable head 110 to become locked in the closed position, as it is trapped inside notch 128x, where it is blocked by vertical side 130 from returning to the open position. In this way, stop element 128 is sized and shaped to keep movable head 110 in the closed position, and prevent movable head 110 from moving to the open position.

In this position, movable head 110 is significantly closer to fixed head 108 than the open position of FIG. 11A. While there is still a gap or separation between the heads, it may be appreciated that a bundle of leaves trapped between the heads in this position will largely be retained, even though some may fall out. This position, corresponding to movable head 110 being trapped inside notch 128x, may be designated as the first closed position.

From the first closed position of FIG. 11B, force 115 may continue to be applied to movable head 110. Due to the sloping side 129, movable head 110 will respond to the force by moving further along sloping side 129 and side surface 125 until it passes beyond notch 128x and becomes entrapped in notch 128y. This result is illustrated in FIG. 11C.

It may be seen that with movable head 110 in notch 128y, the separation between heads is reduced even further so that the tines touch or almost touch. This may be designated as the second closed position. It is to be appreciated that the second closed position is a more tightly closed and differently-shaped space than the first closed position of FIG. 11B. Accordingly, locking mechanism 112 may be said to optionally include a plurality of stop elements 128 corresponding to a plurality of closed positions, where each stop element defines a distinctly sized and shaped substantially enclosed space between the heads.

FIGS. 11B and 11C show an arrow 132 directed downward towards top surface 123 at a point where top surface 123 is continuously connected with side surfaces 125 and where top surface 123 is above rake-handle 102, i.e. to the right of pivot point 127. These figures also show an arrow 134 directed upward to the edges of side surfaces 125, at a point where top surface 123 is cut away from its junction with side surfaces 125 and where side surfaces 125 are below horizontal, i.e to the left of pivot point 127. In order to release movable head 110 from the closed position, including either the first or second closed positions in the example, a force may be applied to locking mechanism 112 in the directions and positions shown by either arrow 132 or arrow 134.

The result of applying such a force is shown in FIG. 11D. As indicated, the force will cause locking mechanism 112 to return to the substantially horizontal rest position and open up space between the bottom edge of side surfaces 125 and the bottom edge of cut-out portion 122. Moving head 110 will thereby be released from whichever notch it happens to be in, i.e 128x or 128y. As a result, the internal bias on movable head 110 will no longer be restrained, and movable head 110 will respond by returning to the open position as shown by arrow 124. FIG. 11E shows movable head 110 back in the open position, with locking mechanism 112 horizontal, as it was when it started in FIG. 11A.

Rake device 100 further includes a second lock 136 to lock movable head 110 in the open position. This state of rake device 100 is shown in FIG. 11F and in perspective view in FIG. 10A. As indicated, second lock 136 comprises a connector such as locking connector 116 configured to fixedly attach movable head 110 to rake-handle 102. Locking connector 116 may be a narrow strip of flexible material such as a wire, string, cord, or thread, that is fixedly attached to movable head 110 and that is configured to releasably connect with a point on rake-handle 102, such as attachment post 114.

According to an option and as shown in the figures, locking connector 116 may be a wire attached to movable head 110 in two places, on opposite sides of rake-handle 102, to provide a stronger connection with movable head 110. An advantage of this configuration is that the wire of locking connector 116 wraps around rake-handle 102, and is in position where it can easily be moved between a non-connected position, i.e where it is not wrapped around attachment post 114, and the connected position, i.e. where it is wrapped around attachment post 114.

When locking connector 116 is connected to or wrapped around attachment post 114, movable head 110 is restrained from movement towards fixed head 108, and is thereby locked in the open position. Accordingly, applying external force 115 to movable head 110 when locked in the open position will have no effect, as movable head 110 will be unable to move towards notches 128. When locking connector 116 is in the non-connected position and not wrapped around attachment post 114, as shown in FIGS. 10B and 11A-11E, there is no restraint on movement of movable head 100, and movable head 100 is free to move between the open and closed positions.

According to some embodiments, the length of rake-handle 102 from the top of grip end 104 to end point 113 may be about 47 inches, with about 3½ inches of that between end point 113 and cut-out portion 122. The width of heads 108 and 110 may be about 14 inches.

The operation of leaf collection device 10, by which leaves distributed on a ground surface may be collected into a leaf collection bag, may now be described.

Upon setting out to collect leaves 28 from a lawn, a user 15 may retrieve frame 12 and leaf collection bag 16. Frame 12 may have ground contacting side 54 already present as a non-removable part of the frame. Alternatively, the user may select a removable ground-contacting side 54 having an appropriate set of rake tines 86, and install side 54 by aligning apertures 88 and 89 and joining the pieces by tightening a connecting wing-nut.

The area or size of frame 12 may be reduced by bringing segments 58 and 59 together so that there is a relatively large overlap between them, thereby reducing the length of side 56. Open end 18 of leaf collection bag 16 is then fitted around the now relatively smaller outer periphery of frame 12. Segments 58 and 59 are then moved apart, reducing the overlap, so that the length of side 56 and the corresponding area of frame mouth 13 are increased. This creates a closer and more tight fit with open end 18 of bag 16, so that bag 16 is firmly attached to frame 12. The mouth 13 of frame 12 is lined up with, or coincident to, bag opening 20. One or more clips 74 may be snapped into place to further secure bag 16 to frame 12.

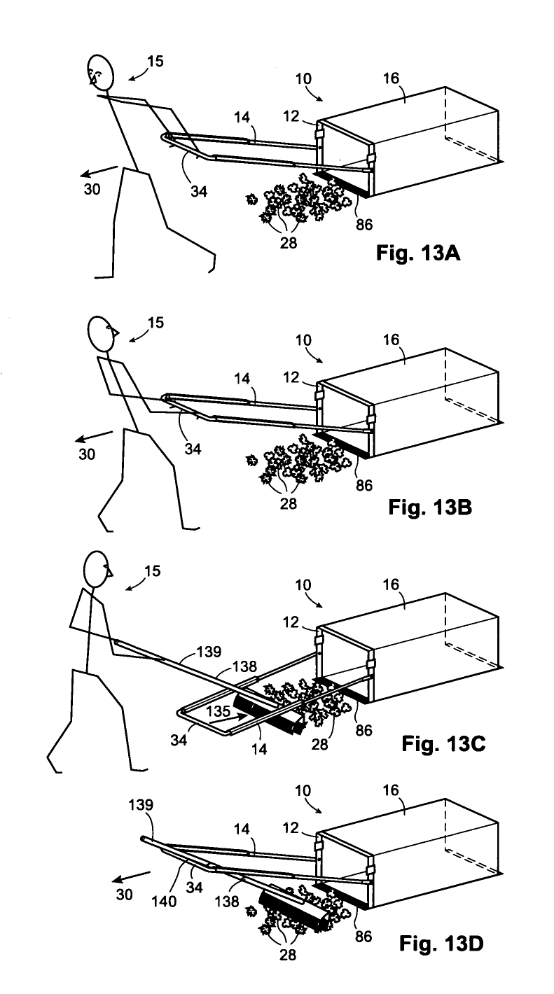

Leaf collection device 10 may be placed in the side or leaf gathering position, as shown in FIG. 13A. As noted, in this position frame 12 is adjacent to the ground, and bag protector 76 is under the bottom side of leaf collection bag 16. The user may then grip handle 14 at cross bar 34, raise the handle to a comfortable height, and walk along the ground while pulling device 10 forward, in the direction of arrow 30, such that rake tines 86 passes through leaves 28 on the ground. The leaves will be gathered together into a cluster or pile on the ground in front of device 10.

There are a variety of ways that user 15 may move with device 10. In FIG. 13A user 15 faces forward with his hands behind him on cross-bar 34. The user may instead face device 10, grip cross-bar 34 with hands in front, and walk backward in forward direction 30, as shown in FIG. 13B.

In either case, at any time the user may stop moving forward, lay down handle 14, and push or rake the pile of gathered leaves 28 into leaf collection bag 16 through bag opening 20, as shown in FIG. 13C. In this way the pile of leaves are removed from the lawn and deposited into the interior of the bag, and the user can resume moving rake device 10 over the ground.

In the figures user 15 is using a rake 138 having a handle 139. Rake 138 may be any type of rake, including a conventional rake with flexible tines, a rake with rigid tines, or rake device 100 described above.

When raking leaves while using device 10 it is advantageous to use a rake with short tines that are oriented 90 degrees from the handle, and where the handle is relatively short, as shown in the figures. This is because when user 15 stops moving forward and prepares to rake, he or she is right in front of, or in line with, the pile of leaves and bag opening 20. From that position it is relatively quick and easy to simply push the leaves forward into bag 16, in the direction shown by arrow 135 in FIG. 13C. For this type of “push raking”, using a rake with short tines oriented 90 degrees from the handle is advantageous. It is to be appreciated that rake device 100 functions as this type of rake because fixed head 108 is relatively short, and is located at and oriented 90 degrees from the far end or tip of rake-handle 102.

It is also preferable that rake 138 have flexible tines, as flexible tines will reduce the risk of the tines jamming with rake tines 86 of frame 12. Accordingly, it is to be appreciated that it is advantageous to use rake device 100, as fixed head 108 is sufficiently rigid to push the leaves effectively, while retaining sufficient flexibility in rake tines 111 to reduce the risk of jamming in rake tines 86. Another option is for the user to rotate the handle about 180 degrees so that the heads flip completely around and tines 111 face upwards instead of towards the ground. The leaves may then be pushed with the broad flat part of single piece material 118.

In order to have rake 138 available and readily accessible, user 15 may choose to carry the rake in one hand while pulling device 10 with the other hand, facing either forward or backward as shown in FIGS. 13A-B. Users may decide on their own preference as to how frequently they stop to rake the leaves. For example, a user may prefer to move device 10 for a relatively long time so that a larger pile of leaves is gathered, or alternatively stop more frequently but have a relatively smaller pile of leaves, which can be pushed into the bag more quickly. To save more time, the user may choose to keep holding handle 14 in one hand rather than set it down, and hold and push rake 138 with the other hand.

Another method of using device 10 with rake 138 is shown in FIG. 13D. In this figure rake 138 is rake device 100. In this method, instead of the user holding rake 138 in hand as described above, rake 138 may be placed on the ground in front of frame 12, with handle 139 laid over cross-bar 34, so that the two handles come in contact at intersection point 140. User 15 may then walk in forward direction 30, facing either forward or backward, with one hand on cross-bar 34 and the other hand gripping handle 139 of the rake and cross-bar 34 of device 10 together, at intersection point 140. An advantage of pulling rake 138 along with device 10 is that rake 138 improves the gathering of leaves 28. More particularly, the combined effect of two sets of tines being pulled forward results in more leaves being gathered from the area covered by movement of device 10. Further, with this method rake 138 is optimally positioned for pushing leaves into the bag, as the rake tines are on the ground, handle 139 is raised, and the user's hand is already holding the handle. By contrast, when rake 138 is carried in hand as described above, it needs to be repositioned for raking each time the user stops. Optionally, a hook (not shown) may be included on handle 102 of rake device 100 or on crossbar 34 to hold the rake to crossbar 34, so that the user does not always have to hold the items together.

It is to be appreciated that rake device 100 is optimally suited to work with leaf collection device 10.

At any time, but particularly when the leaves have been collected or when bag 16 is substantially full, the user may put device 10 in the upright position shown in FIG. 4C. This may be done by pivoting handle 14 to the trailing side of frame 12, so that cross-bar 34 is behind the closed end 19 of the bag, lifting frame 12 so that the frame is substantially above the ground, and extending retractable support legs 46 to provide a stable base on which to stand. In the upright position the leaves will naturally fall to a deeper or lower position in the interior of bag 16. In addition, in the upright position the user may press down upon the leaves in the bag to pack them to a deeper position.

Upon completion, bag 16 may be removed from device 10 by removing clips 74, and by reducing the size of frame 12 by bringing segments 58 and 59 of side 56 closer together, increasing their overlap as described above.

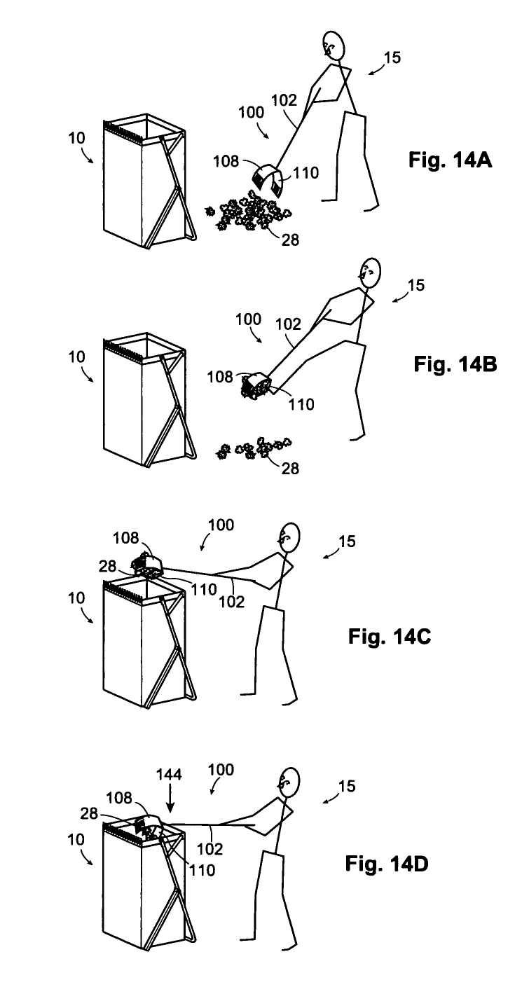

FIGS. 14A-D illustrate operation of rake device 100 to collect leaves on a ground surface. In the figures user 15 is holding rake-handle 102 adjacent a pile of leaves 28 and device 10 in the upright position. Instead of device 10 rake device 100 could similarly be used with any other type of disposal container, such as a garbage can.

In FIG. 14A rake device 100 is in the open position. User 15 moves the pair of heads over a portion of the distributed leaves so that a group or bundle of leaves are positioned within the space defined by the heads. In FIG. 14B the user pushes movable head 110 towards fixed head 108 with the user's foot. As described above, pushing movable head 110 sufficiently moves head 110 into one of the notches 128 and activates locking mechanism 112, which locks the heads into a closed position. In the closed position the space between the pair of heads is substantially enclosed, and the portion of distributed leaves are trapped inside the substantially enclosed space between the heads. In FIG. 14C the user lifts rake device 100 so that the pair of heads holding the trapped leaves are adjacent to the open top of upright device 10. More particularly, raking end 106 with heads in the closed position is held above upright device 10.

In FIG. 14D, user 15 activates locking mechanism 112 to release the heads from the closed position. This may be done by applying a force along arrows 132 or 134, as described above in FIGS. 11B-C. Applying a force in the position shown by arrow 132 may be achieved, for example, by the user striking down on top surface 123, between adjustment post 114 and end point 126, with a closed fist. The user would hold raking-handle 102 with one hand so that the other hand is free to apply the force. Alternatively, a force may be applied in the position shown by arrow 134 by the user forcefully lowering rake device 100 so that the lower edges of side surfaces 125, in the position shown by arrow 134, strike an upper edge of frame 12. It is to be appreciated that for this method to be effective the disposal container used should have a hard upper edge. In the example shown in the figures, the user swings rake device 100 forcefully downward in the direction shown by arrow 144, so that the upward force is received from below, along arrow 134, when side surfaces 125 strike the upper edge of frame 12 of device 10.

With either method of applying a force, the force of the strike will jar locking mechanism 112 to pivot back to its rest position, and release movable head 110 from the lock of the closed position. Movable head 110 will then move or return to the open position under its internal bias. In the open position the space between the heads expands to the maximum, and the leaves are released from their trapped position between the heads and fall into the container. Upon disposing of this batch of leaves, the user can return to the leaves that may remain on the ground and dispose of another batch in the same manner.

It is to be appreciated that leaf collection device 10 provides an improved method of collecting leaves distributed on a ground surface such as a lawn.

As noted, the conventional approach involves raking leaves in a section of the lawn into a pile, picking up a bundle with both hands and dropping them into an upright leaf collection bag. While raking can be done upright, picking up the leaves requires repeated bending down and straightening up. Further, every time a pile is completed the user needs to drop the rake to free both hands, which necessitates a subsequent further bending over to pick up the rake. Yet another aspect is that when a leaf collection bag is first used and is empty, it can easily tip over and not stay upright, particularly if a there is any wind.

By contrast, device 10 enables a user to similarly collect a lawn full of leaves into the collection bag with little or no bending over, since the user is able to remain substantially upright when both pulling device 10 through the leaves, and when raking gathered leaves into leaf collection bag 16. The pivotable handle provides increased convenience, since it enables users to hold the handle at a level that is most comfortable for their height. Further, since many or most users will be able to hold rake 138 with one hand while holding handle 14 with the other, and rake without having to lay down handle 14, device 10 even substantially reduces the number of incidents of bending over for a dropped handle or rake. There is also no issue of an empty leaf collection bag falling over and needing to be picked up. In effect, use of device 10 transforms leaf collection from a substantially “vertical” activity to one that is substantially “horizontal”. It is to be appreciated that being able to stay upright and greatly reduce bending over results in less fatigue, strain and stress, likelihood of injury, and pain (such as back pain) to the user.

It may also be noted that the conventional approach to leaf collection generally requires the user to drag or otherwise move a heavy leaf collection bag. This occurs because every time the user completes a pile positioned near the upright bag, he or she will then move on to raking leaves located in another part of the lawn, further away from the bag. As a result, the user will then also need to move the bag to be close to the next pile of leaves being raked. By then the bag will be at least partly filled, possibly by half or more, and may well be heavy. However, unlike device 10 which provides a convenient handle and a low friction slide sheet that protects the bag and makes it easier to pull across the lawn, a plain leaf collection bag provides only the poor grip available from the edge of the open top, and no protection for the bag in contact with the lawn. If the user chooses not to move the bag and to leave it in place, that results in the user having to walk a long distance back to the bag from every other point in the lawn where a new pile is made, for every handful of leaves to be deposited. It is likely that most users will find that alternative to be even more inconvenient, and will choose to move the bag.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly or components that are superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted. It is understood, for the purposes of this document, that the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

1-36. (canceled)

37. A leaf collection device to facilitate collection of leaves distributed on a ground surface into a leaf collection bag, the leaf collection device comprising:
a frame defining a mouth and having a forward side and a trailing side, the frame being sized and shaped to attach at the trailing side to a periphery of an opening in the leaf collection bag, to maintain the bag opening coincident with the mouth of the frame; and
a handle to provide a grip for a user to move the device, wherein the handle is attached to the frame and oriented towards the forward side of the frame;
wherein, upon placing the device in a side position wherein the frame is adjacent to the ground, the device may be moved by the handle in a forward direction, and leaves on the ground may be raked into the bag through the bag opening.

38. The leaf collection device according to claim 37, wherein the handle is oriented transverse to the mouth of the frame.

39. The leaf collection device according to claim 37, wherein the handle is pivotally attached to the frame.

40. The leaf collection device according to claim 39, further including a releasable lock between the handle and the frame, to selectively fix the handle in a forward orientation to the frame.

41. The leaf collection device according to claim 37, wherein the handle includes a substantially horizontal gripping portion.

42. The leaf collection device according to claim 39, wherein the handle is pivotable to the trailing side of the frame.

43. The leaf collection device according to claim 42, wherein upon pivoting the handle to the trailing side of the frame the handle may be configured to provide a base to support the leaf collection device in an upright position wherein the frame is elevated substantially above the ground.

44. The leaf collection device according to claim 43, wherein the base supporting the device in the upright position includes a support leg attached to the handle.

45. The leaf collection device according to claim 44, wherein the support leg is retractable, wherein the support leg is retracted when the leaf collection device is in the side position, and is extended, to provide an enhanced base of support, when the leaf collection device is in the upright position.

46. The leaf collection device according to claim 47, wherein the frame is expandable in size,
wherein when the frame is expanded an interior of the mouth defines a larger area than when the frame is not expanded,
and wherein in use the frame is placed inside the bag opening and is expanded to make substantially close contact with the inner surface of the bag opening.

47. The leaf collection device according to claim 46, wherein a rigid outer structure of the frame includes overlapping portions that are movable between a first position having greater overlap and a second position having lesser overlap;
wherein the position having lesser overlap corresponds to the frame defining a larger interior area.

48. The leaf collection device according to claim 37, further including a bag protector operatively connected to the frame, the bag protector being sized and shaped to substantially cover a side of the leaf collection bag adjacent to the ground when the leaf collection device is placed in the side position.

49. The leaf collection device according to claim 37, further including rake tines attached to the frame,
wherein the rake tines are configured to be in contact with the ground surface when the leaf collection device is in the side position.

50. A leaf collection device to facilitate collection of leaves distributed on a ground surface into a leaf collection bag, the leaf collection device comprising:
a planar surface;
a ground-contacting element attached to the planar surface;
a frame attachable to the planar surface and defining a mouth and having a forward side and a trailing side, the frame being sized and shaped to attach at the trailing side to a periphery of an opening in the leaf collection bag, to maintain the bag opening coincident with the mouth of the frame; and
a pulling element operatively connected to the ground-contacting element, to provide a means for moving the leaf collection device;
wherein the device may be moved by the pulling element in a forward direction, and leaves on the ground may be raked into the bag through the bag opening.

51. A rake device to collect leaves distributed on a ground surface, the rake device comprising:
a handle having a grip end and a raking end;
a pair of heads including a fixed head and a movable head positioned proximate the raking end of the handle, the movable head being movable between a closed position wherein the pair of heads define a substantially enclosed space, and an open position wherein the pair of heads do not define a substantially enclosed space; and
a locking mechanism positioned proximate the movable head, to lock the movable head in the closed position and to release the lock of the movable head from the closed position, the locking mechanism being configured to lock the rake device in the closed position by application of force urging the movable head towards the fixed head;
wherein a user holding the device at the grip end of the handle may move the movable head from the open position to the closed position by pressing a foot on the movable head.

52. The rake device according to claim 51, wherein the movable head is biased to the open position;
wherein, upon releasing the lock from the closed position, the movable head is urged to the open position.

53. The rake device according to claim 52, wherein the locking mechanism includes a stop element sized and shaped to keep the movable head in the closed position, and prevent the movable head from moving to the open position.

54. The rake device according to claim 53, wherein the locking mechanism includes a plurality of stop elements corresponding to a plurality of closed positions, each stop element defining a distinctly sized and shaped substantially enclosed space.

55. The rake device according to claim 51, further including a second lock to lock the movable head in the open position.

56. The rake device according to claim 55, wherein the second lock comprises a connector configured to fixedly attach the movable head to the handle.
